(19) United States
(12) Patent Application Publication
(10) Pub. No.: US 2026/0326948 A1
(43) Pub. Date: Oct. 22, 2026

(54) Assembly Station for the Automatic Assembly of a Connecting Element on a Cable Harness and Method for Producing a Cable Harness

(71) Applicant: Illinois Tool Works Inc., Glenview, IL (US)

(72) Inventors: Gerit Vollmer, Linden (DE); Sven Sanchez Burger, Ingolstadt (DE); Peter Buhl, Otterberg (DE)

(21) Appl. No.: 19/562,547

(22) Filed: Mar. 10, 2026

(30) Foreign Application Priority Data
Mar. 17, 2025 (DE) 10 2025 110 102.7

(51) Int. Cl. B65B 13/02; B60R 16/02

(52) U.S. Cl. CPC B65B 13/027; B60R 16/0207

(57) ABSTRACT

An assembly station for producing a vehicle cable harness installs connecting elements that bundle individual electrical lines into a cable strand. Each connecting element includes a base section, a flexible retaining section with a free end, and a locking section with an insertion opening. The station positions the connecting element adjacent to the cable strand, wraps the retaining section around the strand, and feeds the free end through the insertion opening of the locking section to close the element around the bundle. Automated handling and insertion secure the connecting element and hold the lines together in the desired arrangement. The station enables consistent and repeatable installation of bundling elements during automated cable harness production.

### RELATED APPLICATION

The present application claims the benefit of German Patent Application Nos. 10 2025 110 102.7, filed Mar. 17, 2025, titled “Assembly Station for the Automatic Assembly of a Connecting Element on a Cable Harness and Method for Producing a Cable Harness,” the contents of which are hereby incorporated by reference.

### BACKGROUND

Cable harnesses are used whenever complex multi-strand wiring is needed. In general, the terms “cable set” and “cable harness” as used herein are intended to generally mean a connection of a plurality of individual cables or individual wires, which are typically arranged in a particular geometry, for example, a branched tree geometry. A cable harness is particularly an often ready-made bundling of individual leads that transmit signals (information) or work currents (energy). The leads are routed as a cable harness and wrapped or held together by clamps, cable ties, twine, or hoses. Such a cable set finds particular use as a prefabricated component in the field of the automotive industry and serves to supply electrical energy to electrical components arranged in the vehicle.

Each type of vehicle with different equipment typically has a different cable set or cable harness required. Each electrical equipment change will result in a change in the cable set.

Thus, only a small number of identical cable sets are often manufactured. In some cases, the cable sets are even custom-made. This is one of the reasons that the cable sets are manufactured substantially manually. For this purpose, the geometry of the desired cable set is depicted on an assembly support or assembly platform designed as a cable board, for example by pins projecting from the assembly support, along which the cables are laid. On the assembly support, the cables are individually manually laid and wrapped together manually with a fixing strap to secure them or held together by connecting elements, such as cable ties.

In the automotive industry, such cable harnesses often are also manually connected to a fastening apparatus by means of cable ties, wherein this fastening apparatus is then subsequently connected to a vehicle body at the vehicle manufacturer in order to secure the harness.

Due to the typically manual fabrication of cable harnesses, special quality assurance measures are required to ensure the desired function of the particular harness. In safety-relevant areas in particular, such as the brake control (anti-lock braking system) or the control of an airbag, the functional safety of the cable harness must be ensured. Attempts to automate this process have encountered limits.

Fully automated systems, such as robot cells, require high investments and are inflexible in converting to new cable harness variants. While semi-automatic tools exist, they usually only automate the final tensioning and cutting of the cable tie strip after the operator has already completed the most laborious and ergonomically most challenging step-manually inserting the end of the strip into the locking head.

### SUMMARY OF THE DISCLOSURE

The present disclosure relates generally to an assembly station, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically shows, in an isometric view, an exemplary embodiment of the assembly station according to the disclosure in a state in which a connecting element to be mounted is being fed to the assembly station.

FIG. 2 illustrates schematically shows, in an isometric view, the assembly station of FIG. 1 in a state in which the connecting element is inserted into the first and second brackets of the assembly station.

FIG. 3 illustrates schematically shows, in an isometric view, the assembly station of the preceding figures in a state in which the second bracket has been pivoted, together with the area of the connecting element it is holding, to align its free end.

FIG. 4 illustrates schematically shows, in an isometric view, the assembly station in a state in which the guide element has been moved to insert the free end of the retaining section of the connecting element into the lock section.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to the field of producing a cable set or cable harness for a vehicle. In a broader sense, the disclosure relates in particular to a concept with which a cable harness is provided, wherein the cable harness can subsequently be attached to a supporting component of a vehicle chassis of a motor vehicle.

The disclosure addresses the task of specifying a system as well as a method for automatically producing a cable harness for a vehicle, in which a bundling of individual lines for signal and/or power transmission is routed as a cable strand and held together by connecting elements.

A further object of the present disclosure is to provide a solution that allows for simple, rapid, and ergonomically improved production of a cable harness while maintaining high production quality.

The assembly station according to the disclosure is generally suitable for the automated mounting of different kinds or types of fasteners on the cable strand of the cable harness to be produced. For this purpose, the connecting element to be mounted preferably comprises a base section, in particular for mounting on a vehicle part, a flexible retaining section with a free end and an opposite end connected to the base section, and a lock section formed on or at the base section with an insertion aperture, via which the retaining section can be inserted into the lock section via its free end.

The assembly station according to the disclosure is configured to mount the connecting element on the cable strand in an automated manner by placing the flexible retaining section of the connecting element at least partially or in areas around the cable strand and inserting the free end of the retaining section of the connecting element through the insertion aperture of the lock section into the lock section of the connecting element. This solves the core problem of the prior art by fully automating the manual and error-prone insertion step.

In an advantageous embodiment of the assembly station according to the disclosure, it comprises a first bracket for holding the base section and/or the lock section of the connecting element as needed and a second bracket for holding at least one area of the flexible retaining section as needed.

In particular, it is provided that the second bracket is designed to be pivotable so that the area of the flexible retaining section held by it is folded down such that the free end of the retaining section faces the insertion aperture of the lock section. In this embodiment, the assembly station further comprises a guide element, which is movable relative to the first bracket and inserts the free end of the folded-down retaining section into the lock section through the insertion aperture.

This interaction of the three core elements (first bracket, second bracket, guide element) forms a robust and reliable mechanical solution.

According to embodiments of the disclosure, it is provided that the assembly station is configured, in a synchronized manner, sequentially and according to a previously determined or determinable sequence of events and in an automated manner, to first place the retaining section of the connecting element around the cable strand and then to insert and guide the free end of the retaining section into the lock section through the insertion aperture of the lock section.

This design ensures reliable and repeatable assembly. The specified, synchronized procedure minimizes the susceptibility to errors due to human intervention and ensures a consistently high assembly quality. In addition, the defined event sequence allows for precise cycle time scheduling and optimization of the entire production process.

A key advantage of this design is in the reliability of the process and traceability. A software-driven sequential flow allows for accurate logging of each step, which is critical to quality assurance as part of Industry 4.0 concepts and dramatically simplifies troubleshooting of faults.

In addition, an electromagnetic actuator offers superior controllability of speed and force over pneumatic alternatives, which allows for more gentle handling of the components and minimizes wear. As an alternative to an electromagnetic actuator, pneumatic cylinders for particularly high forces or piezo actuators for extremely fast and precise small movements could also be used, depending on the specific requirements of the assembly process.

According to a preferred embodiment, it can be provided that at least one actuator, in particular an electromagnetic actuator, is associated with the assembly station for driving the necessary and drivable mechanical components as required for the mounting of the connecting element on the cable strand.

The use of an actuator allows for full automation of mechanical movements, significantly reducing physical strain for the operator and improving ergonomics in the workplace. An electromagnetic actuator offers the advantage of precise, rapid, and silent control, with simultaneous compact design and low energy consumption. This results in a reliable and low-maintenance useful life of the equipment.

According to a further embodiment, the assembly station comprises a first bracket for holding the base section and/or the lock section, a second pivotable bracket for holding the flexible retaining section, and a movable guide element that inserts the free end of the folded-down retaining section into the lock section.

This mechanical three-way division of the tasks (securing, pivoting, inserting) among specialized components allows a particularly robust and functionally reliable design. Each component can be optimally designed for its specific function, maximizing the precision of the entire operation. This concept ensures that the flexible strap end is reliably guided into the small opening of the lock section even with slight variations of the connecting element or the cable strand.

Dividing the functions into three separate, mechanically decoupled assemblies significantly increases the modularity and ease of maintenance of the system. For example, the first bracket may be designed as a replaceable mold cavity to adapt the station to various types of connecting elements with minimal effort without having to change the pivoting or feeding mechanics.

Another advantage is the robustness, as each assembly unit can be optimally designed for its specific load-static holding, rotational movement, or linear force transmission. As an alternative to this three-component system, a solution with a small, multi-axis articulated robot would be conceivable, but this would be associated with significantly higher costs and more complex control.

In an alternative embodiment, it may be provided that the first bracket comprises a receiving area, in or from which the base section and/or the lock section of the connecting element to be mounted is receivable or held, at least partially or in sections.

A defined receiving area facilitates the insertion of the connecting element significantly and ensures its exact positioning and orientation. This prevents the element from slipping during the automated assembly process, which is essential for process reliability. Precise positioning is the basic requirement for the guide element to be able to accurately insert the end of the strap into the lock section.

The defined receiving area serves as a “poka-yoke” device (protection against mishandling) that prevents incorrect insertion of the connecting element by the operator by design and thus increases the process reliability without additional sensors or inspections. This reduces learning time for new employees and increases production first pass yield.

As an alternative to the purely passive, form-fitting receptacle, active clamping elements, for example small, spring-loaded, or pneumatic grippers, or even a vacuum suction device could be used to actively secure the connecting element, which can counter vibrations at very high process speeds.

According to a preferred embodiment, the receiving area is at least partially or in areas arranged in a manner complementary to the base section and/or to the lock section, so that it/they are at least substantially receivable in a form-fitting manner into the receiving area; and/or that, in an area facing away from the second bracket, the first bracket comprises a channel section connected to the receiving area, along which a movement of the retaining section is guided.

A form-fitting, complementary receiving area ensures the highest possible stability and positioning accuracy of the connecting element, since any play or twisting is prevented. The additional channel section on the first bracket serves as a guide for the strap after threading and ensures that it does not tilt during later clamping and severing.

This combination maximizes mechanical precision and reliability of the entire system.

The form-fitting receptacle further guarantees precise, repeatable positioning in the micrometer range, which is essential for reliably targeting the small insertion aperture of the lock section. The channel section performs an important function after threading: It guides the protruding end of the strap in a controlled manner and prevents it from becoming entangled or interfering with the next automated step, such as tightening.

As an alternative to an integrated channel section, the strap end could also be removed from the work area by a targeted air blast or separate removal pliers.

According to embodiments of the disclosure, it is provided that the receiving area is arranged such that the base section and/or the lock section of the connecting element are insertable into the receiving area in an insertion direction. A defined insertion direction simplifies and speeds manual loading for the operator, as the movement is intuitive and unidirectional.

This reduces the cognitive burden and the time required per loading cycle, which increases the overall efficiency of the semi-automatic station. In addition, the clear direction of movement minimizes the risk of misloading.

The unidirectional insertion motion allows for extremely fast and ergonomic loading by the operator, as it follows a natural push-to-seat motion, further reducing cycle time.

This simplicity reduces cognitive burden and operator fatigue over a long shift.

An alternative configuration would also be conceivable, in which the connecting element is inserted from above (top load) and secured by a cover, which could be advantageous for certain station layouts.

According to a preferred embodiment, the second bracket is pivotally supported between a first position, in which a cantilever area extends substantially opposite the insertion direction and a second position, in which the cantilever area extends toward the receiving area.

This defined pivoting movement between two end positions allows a clear and repeatable folding down of the flexible retaining section around the cable strand. The first position facilitates the placement of the strap, while the second position precisely positions the strap for the insertion process. This kinematics forms the mechanical core for the automation of the strapping process.

This precisely defined pivoting movement between two mechanically defined end stops ensures the highest repeatability of the strapping process. The first, open position creates maximum clearance for the placement of the strap, while the second, closed position positions the end of the strap exactly in front of the insertion aperture.

As an alternative to a purely pivoting movement, a curve guidance by means of a cam-controlled linkage could also be realized, which enables a more complex, non-circular movement, for example to navigate around interfering contours on the cable strand.

In an alternative embodiment, it may be provided that the second bracket is configured to bend the flexible retaining section at a substantially 90-degree angle when pivoting; and/or that the second bracket comprises a guide area for receiving an area of the retaining section in a form-fitting manner; and/or that the cantilever area comprises a window area, through which the guide element extends.

The 90-degree bending is a particularly efficient movement to place the strap around the cable strand and optimally align it for linear feeding by the guide element. A form-fitting guide area in the second bracket prevents the strap from slipping during the swiveling movement. The window area creates the necessary space for the guide element to reach and insert the strap end without colliding with the second bracket, allowing for a compact and integrated design.

The 90-degree bend also represents the shortest and fastest way to place the strap around a typically round cable strand and align it perfectly for linear feeding. The window area is a clever design detail that enables a very compact design by allowing the movement spaces of the guide element and the second bracket to overlap without any collision. An alternative design without a window area would require a longer and more protruding design of the guide element, which could sacrifice stability and precision.

According to a preferred embodiment, it is provided that the assembly station, in an area between the first and second brackets, comprises a circular segment-shaped receiving area configured to receive a section of the cable strand; and/or that the guide element is configured as a sliding element and is linearly movable relative to the first bracket.

The circular segment-shaped receiving area for the cable strand ensures that it is positioned securely and centrally during the strapping, which results in uniform and central fastening. The design of the guide element as a linearly movable sliding element is a mechanically simple, robust, and cost-effective solution for insertion movement. This linear movement is also very precisely and quickly controllable.

The circular segment-shaped receiving area further automatically centers the cable strand and ensures that the connecting element is placed exactly centrally on the cable strand, which is important for a professional appearance and even force transmission.

The design of the guide element as a simple sliding element running on a standard linear track is extremely inexpensive, robust, and low-maintenance as it utilizes proven industrial components. Alternatively, the receiving area for the cable strand could be configured as an adjustable V-shaped receptacle to cover an even wider range of cable harness diameters.

According to embodiments of the disclosure, it is provided that the guide element is supported pivotally and is configured, in a purely pivoting movement or in a superposition of a pivoting and a linear movement, to insert the free end; and/or that the guide element comprises a guide area for receiving an area of the retaining section in a form-fitting manner.

Swiveling or superposed movement of the guide element may be beneficial in structurally tight spaces, allowing for more complex motion sequences to avoid obstacles. A separate form-fitting guide area on the guide element itself ensures that the strap end is securely grasped and guided during the entire insertion movement. This further increases process reliability, especially at high speeds or with very thin straps.

The possibility of superimposed pivoting and linear movement (superposition) provides the guide element with additional flexibility to actively “thread” the end of the strap into the opening rather than pushing it only rigidly, which further increases the process reliability with slight tolerance deviations. A dedicated guide area on the guide element gripping the strap end acts like tweezers and provides for absolutely secure guiding during the critical insertion phase.

As an alternative to a mechanical guide area, the end of the strap could also be held to the guide element by a targeted vacuum flow.

In an alternative embodiment, it may be provided that the assembly station further comprises a device for automatically tightening and severing the retaining section; and/or that the lock section comprises a snap or latch connection; and/or that the assembly station comprises an integrated inspection device that detects whether the free end is successfully inserted.

Integration of automatic tightening and severing into the same cycle eliminates a subsequent work step and maximizes time savings. The inspection device (e.g., an optical sensor or mechanical switch) eliminates the need for separate manual quality control and ensures that only correctly mounted parts exit the process. This significantly increases the rejection rate and overall quality of production.

Integration of the tightening and cutting functions as well as inspection into a single, seamless process cycle represents the maximum level of automation for a semi-automatic station and eliminates any need for rework or separate control steps. The inspection device (e.g., a light barrier sensor detecting the fed-through strap end, or a camera) allows for 100% real-time quality control and can log the data for each individual assembly operation.

As an alternative to the integrated inspection, correct tightening could also be ensured via torque or current monitoring on the drive of the tightening tool.

The assembly system according to the disclosure, which comprises at least two of the described assembly stations on an assembly platform (e.g., an assembly table), allows multiple connecting elements to be mounted simultaneously on a cable strand.

By means of a common control unit, the stations can be activated synchronously, resulting in a massive increase in productivity. Thus, with a single activation, an operator can attach an entire cable strand at multiple points simultaneously.

The method according to the disclosure for producing a cable harness comprises providing such an assembly system, arranging a cable strand on the platform, and simultaneously activating the assembly stations. This operationalizes the advantages of the system and enables scalable and highly efficient harness production.

The method according to the disclosure for semi-automatic assembly, which automates the steps of holding, pivoting, and moving the guide element, defines the core process that realizes the ergonomic and time-related advantages. It accurately describes the sequence that eliminates the manual threading step.

According to a preferred embodiment of the method, it is provided that it further comprises the automated steps of tightening the inserted retaining section and severing an excess end section.

Inclusion of these steps in the automated cycle completes the assembly process within a single, fast workflow. The operator no longer needs to perform any further manual actions after activation, minimizing cycle time and maximizing efficiency. This results in a one-touch principle that is both ergonomically optimal and maximally productive.

In addition, further alternative embodiments are conceivable. The actuator could alternatively be operated pneumatically or hydraulically, depending on the force and speed requirements. Control could be via a simple foot switch operation or a two-handed safety operation. Sensors could not only check for successful insertion, but also for proper presence of the cable strand and connecting element prior to activation to prevent false cycles.

The entire station could be modular in design to allow for a quick change of receptacles for different types of connecting elements.

The disclosure thus presents a semi-automatic assembly station that solves a central challenge in the production of cable harnesses: the time-consuming and ergonomically burdensome manual assembly of cable ties. Rather than only automating tensioning and cutting as in previously used tools, the disclosure targets the most critical step-inserting the flexible strap end into the locking head. As a result, the assembly station closes the gap between simple hand tools and capital-intensive, fully automatic robotic equipment and provides an economically attractive solution for significantly increasing efficiency and workplace quality.

The technical core of the device is a precisely coordinated mechanical system consisting of three main components. A fixed receptacle immovably secures the base and lock sections of the cable tie and ensures an exact target position. A pivotable arm that holds the flexible strap end places it around the positioned cable strand in a fast and highly repeatable motion. Then, a linearly movable slider completes the operation by forcefully and accurately pushing the aligned strap end into the insertion aperture of the lock section, thus closing the connection. This robust interplay ensures a reliable assembly that is independent of human skill.

For the operator, there is a maximally simplified and ergonomic workflow. The process is limited to simply placing the connection element and the cable strand into clearly defined receptacles and subsequently activating the automated cycle, for example via a foot switch.

The complex and repetitive work of manual threading is eliminated completely. Not only does this dramatically reduce cycle time, but it also minimizes the risk of forced postures and repetitive strain injuries (RSI), which sustainably improves employee health and satisfaction.

Beyond the core function, the assembly station integrates further automated process steps into a seamless overall flow. Upon successful strap insertion, the device may automatically tension the cable tie to a predefined tensile force and succinctly sever the protruding end. A significant advantage is also the optional integration of an inspection device.

For example, using an optical sensor or a micro-pushbutton, it can detect in real time whether the strap has been inserted correctly, thus eliminating the need for separate downstream quality control. The result is a “first-time-right” approach that reduces waste and enables 100% process control right at the workstation.

The disclosure is also designed as a scalable system to meet the requirements of mass production. Several of the assembly stations described can be arranged on a larger assembly platform or assembly table.

Using a common controller, all stations can be activated synchronously, allowing an operator, with a single action, to equip a cable harness with connecting elements at numerous points simultaneously. This multiplies the productivity gain and is ideal for equipping complex cable boards on which long cable strands with many attachment points are produced.

Another key advantage of the design is its flexibility and adaptability. The receptacles for the connecting element and the cable strand can be designed as modular, easily interchangeable mold cavities. This allows the assembly station to be adapted to different sizes and types of cable ties or varying cable harness diameters with minimal effort and at low cost. Instead of having to build a completely new fixture for each new variant, it is sufficient to replace smaller components, which increases investment security and makes the system future-proof.

The exemplary embodiment of the assembly station 1 according to the disclosure shown schematically in the drawings is part of an assembly system, not shown in the drawings, for producing a cable harness for a vehicle. Such an assembly system typically comprises an assembly platform, for example in the form of an assembly table, on which at least two, preferably several, of the assembly stations 1 shown here are arranged.

The assembly platform is arranged so that a cable strand can be placed according to a predefined pattern, wherein the assembly stations 1 are positioned such that they can each mount a connecting element 20 on the cable strand at the intended locations. The assembly system is preferably configured to drive all assembly stations 1 simultaneously and synchronously to enable highly efficient production.

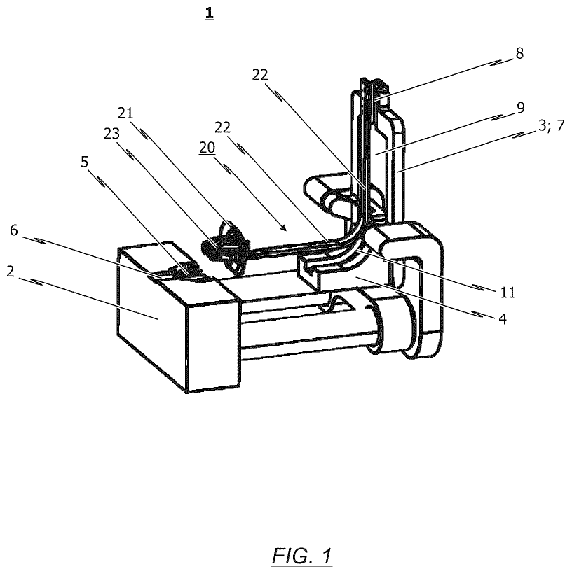

Each connecting element 20 to be mounted, as shown in FIG. 1, has a base section 21, a flexible retaining section 22 extending therefrom with a free end, and a lock section 23 formed on or in the area of the base section 21. The lock section 23 has an insertion aperture that is not explicitly shown, through which the free end of the retaining section 22 can be inserted to form a loop for encircling a cable strand. A latch or clamp connection is provided within the lock section 23, which prevents withdrawal of the inserted retaining section 22.

FIG. 1 shows the assembly station 1 in an initial loaded state. The assembly station 1 comprises a first stationary bracket 2 and a second bracket 3 that is movable relative thereto. The first bracket 2 serves to precisely and immovably receive the base section 21 and the lock section 23 of the connecting element 20. A receiving area 5 is provided for this purpose, which is advantageously designed to be form-fitting and complementary to the geometry of the lock section 23.

This has the advantage that the connecting element 20 is positioned without any play, which is a basic requirement for the subsequently, reliably automatically inserting the retaining section 22. The form-fitting receptacle functions as a poka-yoke system, which structurally prevents incorrect insertion by the operator. The first bracket 2 is adjoined by a channel section 6, the advantageous function of which lies in the latter process sequence, in that it removes the protruding end of the retaining section 22 after tightening.

The second bracket 3 is shown in this illustration in a first, open position, in which it is ready to receive the flexible retaining section 22. The second bracket 3 is configured as a pivotable cantilever area 7, which comprises a guide area 8 in the form of a channel or a groove. This guide area 8 receives a section of the retaining section 22 and securely holds it during the rapid pivoting movement.

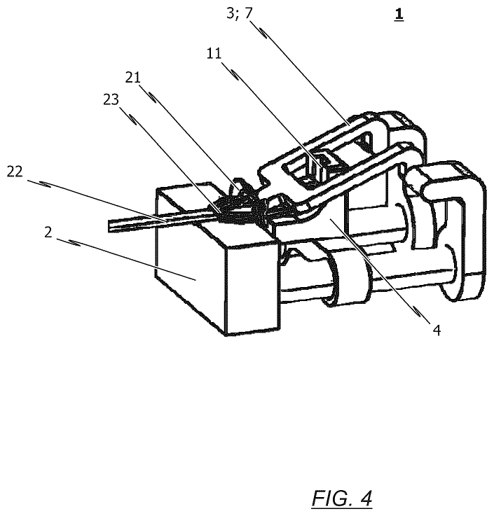

Also visible is a window area 9 in the cantilever area 7, the function of which becomes clear in connection with FIG. 4. Furthermore, a linearly movable guide element 4 can be seen that remains in its retracted position in this phase. The guide element 4 also comprises a guide area 11, which serves to grip and guide the free end of the retaining section 22.

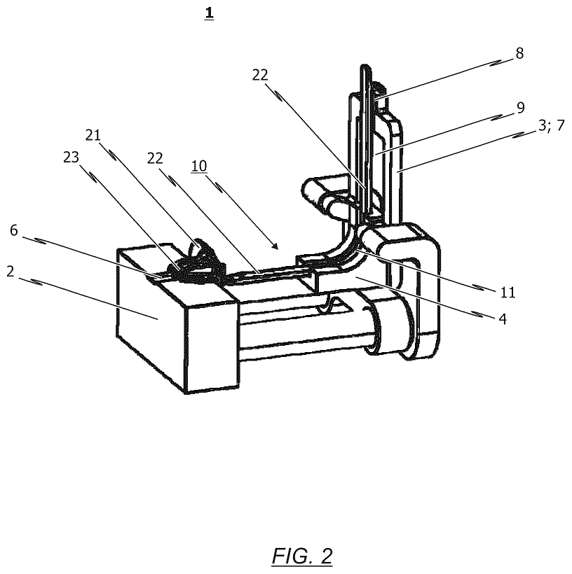

FIG. 2 shows the assembly station 1 after a connecting element 20 has been fully inserted. The lock section 23 now rests securely in the receiving area 5 of the first bracket 2. The flexible retaining section 22 is placed in the guide area 8 of the second bracket 3. A circular segment-shaped receiving area 10 is indicated between the first bracket 2 and the second bracket 3.

This area is for receiving a cable strand not shown in the drawings. The shaping has the advantage that the cable strand is automatically centered and securely held to ensure that it is centrally and evenly wrapped by the retaining section 22. The assembly station 1 is now equipped and ready for activation of the automated assembly cycle.

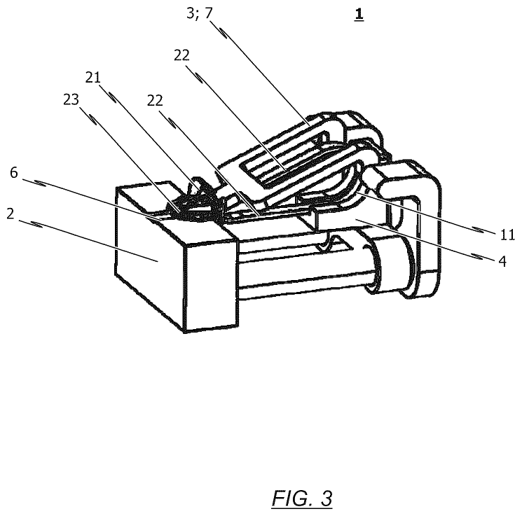

FIG. 3 illustrates the first automated step after activation. The second bracket 3 was pivoted from its first position (see FIG. 2) to a second, closed position. This pivoting movement, which preferably takes place by about 90 degrees, bends the flexible retaining section 22 around the cable strand lying in the receiving area 10. The free end of the retaining section 22 is now exactly aligned with the insertion aperture of the lock section 23, which is held by the first bracket 2.

This step is the decisive advantage of the disclosure, as it fully automates the difficult manual looping and alignment, resulting in tremendous time savings and ergonomic relief for the operator. The movement is rapid, precise, and repeatable.

FIG. 4 shows the subsequent automated step of inserting the strap end. The guide element 4, configured as a sliding element, is moved linearly toward the first bracket 2. The guide area 11 of the guide element 4 thereby captures the free end of the retaining section 22 and pushes it through the insertion aperture into the lock section 23. During this movement, the guide element 4 extends through the window area 9 of the second bracket 3, which allows a collision-free and very compact design of the entire arrangement. Once the strap is latched into the lock section 23, the loop is closed.

Although not shown in the figures, this state is typically followed by automatically tightening the retaining section 22 to a defined tensile force and succinctly severing the protruding end.

Furthermore, an integrated inspection device, also not shown, such as an optical sensor, can detect whether the end of the retaining section 22 has successfully passed through the lock section 23 to ensure 100% quality control in real time. The entire sequence of steps shown in FIGS. 2 to 4 proceeds in a single, rapid, and fully automated cycle after the operator has activated the station.

In this context, it is in particular conceivable that the assembly station 1 further comprises a device for automatically tightening the retaining section 22 of the connecting element 20 in its state of being received at least partially or in areas in the lock section 23 of the connecting element 20, and for automatically severing an end area of the tightened retaining section 22 of the connecting element 20 which has been guided through the lock section 23 of the connecting element 20.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Assembly station
2 First bracket
3 Second bracket
4 Guide element
5 Receiving area of the first bracket
6 Channel section of the first bracket
7 Cantilever area of the second bracket
8 Guide area of the second bracket/of the cantilever area of the second bracket
9 Window area of the cantilever area of the second bracket
10 Receiving area between the first and second brackets
11 Guide area of the guide element
20 Connecting element
21 Base section of the connecting element
22 Flexible retaining section of the connecting element
23 Lock section of the connecting element

What is claimed is:

1. An assembly station (1) of an assembly system for producing a cable harness for a vehicle, in which a bundling of individual lines for signal and/or power transmission is routed as a cable strand and held together by connecting elements (20), wherein each connecting element (20) comprises a base section (21), a flexible retaining section (22) with a free end and an opposite end connected to the base section (21), and a lock section (23) formed at or near the base section (21) with an insertion aperture, through which the retaining section (22) can be inserted into the lock section (23) via its free end, wherein the assembly station (1) is configured to mount a connecting element (20) on the cable strand in an automated manner, and preferably in a fully automated manner, by placing the retaining section (22) of the connecting element (20) around the cable strand, at least partially or in sections, and inserting the free end of the retaining section (22) of the connecting element (20) through the insertion aperture of the lock section (23) into the lock section (23) of the connecting element (20).

2. The assembly station (1) according to claim 1,
wherein the assembly station (1) is configured, in a synchronized manner, sequentially and according to a previously determined or determinable event sequence and in an automated manner, first to lay the retaining section (22) of the connecting element (20) around the cable strand and then to insert the free end of the retaining section (22) of the connecting element (20) through the insertion aperture of the lock section (23) into the lock section (23) of the connecting element (20) and to guide it through the lock section (23); and/or
wherein at least one actuator is associated with the assembly station (1) for driving the necessary and drivable mechanical components of the assembly station (1) as required for the mounting of the connecting element (20) on the cable strand.

3. The assembly station (1) according to claim 1, wherein the assembly station (1) comprises:
a first bracket (2) for retaining, as needed, the base section (21) and/or the lock section (23) of a connecting element (20) to be mounted to the cable strand; and
a second bracket (3) for retaining, as needed, at least one area of the flexible retaining section (22) of the connecting element (20) to be mounted on the cable strand,
wherein the second bracket (3) is configured to be pivotable such that the area of the flexible retaining section (22) of the connecting element (20) held as needed by the second bracket (3) is folded down or may be folded down such that the free end of the retaining section (22) of the connecting element (20) faces or is aligned toward the insertion aperture of the lock section (23) of the connecting element (20) held as needed by the first bracket (2), and wherein the assembly station (1) further comprises:
a guide element (4), which is movable relative to the first bracket (2) and is configured to insert the free end of the folded-down retaining section (22) of the connecting element (20) through the insertion aperture into the lock section (23) of the connecting element (20).

4. The assembly station (1) according to claim 3,
wherein the first bracket (2) comprises a receiving area (5), in or from which the base section (21) and/or the lock section (23) of the connecting element (20) to be mounted is receivable or held, at least partially or in sections.

5. The assembly station (1) according to claim 4,
wherein the receiving area (5) is at least partially or in sections arranged in a manner complementary to the base section (21) and/or to the lock section (23) of the connecting element (20) such that the base section (21) and/or the lock section (23) of the connecting element (20) are at least substantially receivable into the receiving area (5) in a form-fitting manner; and/or
wherein, in an area facing away from the second bracket (3), the first bracket (2) comprises a channel section (6) connected to the receiving area (5), through which a movement of the retaining section (22) of the connecting element (20) is guided or can be guided when the free end of the folded-down retaining section (22) of the connecting element (20) is guided through the lock section (23) of the connecting element (20).

6. The assembly station (1) according to claim 4,
wherein the receiving area (5) is arranged such that the base section (21) and/or the lock section (23) of the connecting element (20) is insertable into the receiving area (5) in an insertion direction.

7. The assembly station (1) according to claim 6,
wherein the second bracket (3) is pivotally mounted between a first position and a second position relative to the first bracket (2), wherein, in the first position of the second bracket (3), at least one cantilever area (7) of the second bracket (3) extends in a direction at least substantially opposite to the insertion direction, and wherein, in the second position of the second bracket (3), the cantilever area (7) of the second bracket (3) extends toward the receiving area (5) of the first bracket (2).

8. The assembly station (1) according to claim 7,
wherein the second bracket (3) is configured to bend the flexible retaining section (22) at a substantially 90-degree angle when pivoting from the first position to the second position; and/or
wherein the cantilever area (7) of the second bracket (3) comprises a guide area (8), preferably in the form of a channel section, which is configured to receive, particularly in a form-fitting manner, and/or guide at least one area of the retaining section (22) of the connecting element (20); and/or
wherein the cantilever area (7) of the second bracket (3) comprises a window area (9) through which, in the second position of the second bracket (3), the guide element (4) extends at least partially or in areas, and at least when the guide element (4) is moved relative to the first bracket (2) in order to insert the free end of the retaining section (22) into the lock section (23) of the connecting element (20).

9. The assembly station (1) according to claim 3,
wherein the assembly station (1), in an area between the first bracket (2) and the second bracket (3), comprises a particularly at least substantially circular segment-shaped receiving area (10), which is configured at least partially or in areas to receive a section of the cable strand, wherein, upon receiving the cable strand section, a particularly central area of the retaining section (22) of the connecting element (20) is arranged between the receiving area (5) and the cable strand section; and/or
wherein the guide element (4) is configured as a sliding element and is linearly movable relative to the first bracket (2).

10. The assembly station (1) according to claim 3,
wherein the guide element (4) is pivotally supported and is configured, in a purely pivoting movement or in a superposition of a pivoting movement and a linear movement, to insert the free end of the folded-down retaining section (22) of the connecting element (20) through the insertion aperture into the lock section (23) of the connecting element (20); and/or
wherein the guide element (4) comprises a guide area (11), preferably in the form of a channel section, which is configured to receive in a form-fitting manner and/or guide at least an area of the retaining section (22) of the connecting element (20), and when the guide element (4) is moved relative to the first bracket (2).

11. The assembly station (1) according to claim 1,
wherein the assembly station (1) further comprises a device for automatically tightening the retaining section (22) of the connecting element (20) in its state of being received at least partially or in areas in the lock section (23) of the connecting element (20), and for automatically severing an end area of the tightened retaining section (22) of the connecting element (20) which has been guided through the lock section (23) of the connecting element (20); and/or
wherein the lock section (23) of the connecting element (20) is configured such that, in a state of being inserted into the lock section (23) of the connecting element (20), at least one area of the retaining section (22) thereof is held therein via at least one snap or latch connection; and/or
wherein the assembly station (1) further comprises an integrated inspection device configured to detect whether the free end of the retaining section (22) is successfully inserted into the lock section (23).

12. An assembly system for producing a cable harness for a vehicle, wherein the assembly system comprises:
an assembly platform in the form of an assembly table; and
at least two assembly stations (1) arranged on the assembly platform according to claim 1,
wherein the assembly platform is configured and serves such that a cable strand is received by or receivable on the assembly platform according to a previously determined or determinable pattern, wherein the assembly stations (1) are arranged and configured on the assembly platform to each mount a connecting element (20) on an area of the cable strand received by the assembly platform, and wherein the assembly system is configured to simultaneously and synchronously control and activate the assembly stations (1), wherein, to activate the mechanical components of the assembly stations (1) simultaneously and synchronously, the assembly stations (1) of the assembly system are preferably associated with a common control device and/or preferably a common actuator.

13. A method for producing a cable harness for a vehicle, wherein the method comprises the following steps:
providing an assembly system according to claim 12;
arranging a cable strand on the assembly platform of the assembly system; and
simultaneously activating the mechanical components of the assembly stations (1) of the assembly system.

14. A method for semi-automatically mounting a connecting element (20) on a cable strand by means of an assembly station (1), wherein the connecting element (20) comprises a base section (21) with a lock section (23) and a flexible retaining section (22) with a free end, wherein the method comprises the following automated steps:
holding the base section (21) and the lock section (23) of the connecting element (20) in a first bracket (2);
holding an area of the flexible retaining section (22) in a second pivotable bracket (3);
pivoting the second bracket (3) relative to the first bracket (2) to fold down the flexible retaining section (22) around a cable strand arranged on the assembly station (1) such that the free end of the retaining section (22) is aligned toward an insertion aperture of the lock section (23); and
moving a guide element (4) relative to the first bracket (2) to insert the free end of the retaining section (22) into the lock section (23) through the insertion aperture.

15. The method according to claim 14, further comprising the following automated steps:
tightening the retaining section (22) inserted into the lock section (23); and
severing an excess end area of the tightened retaining section (22).

16. An assembly station for installing a connecting element on a cable strand of a vehicle cable harness, the connecting element including a base section, a flexible retaining section having a free end, and a lock section having an insertion aperture configured to receive the free end of the retaining section, the assembly station comprising:
a first holder configured to retain the base section and the lock section of the connecting element in a predetermined position relative to the cable strand;
a second holder configured to engage the flexible retaining section of the connecting element and movable relative to the first holder to position the retaining section around the cable strand; and
an insertion member movable relative to the first holder and configured to guide the free end of the retaining section through the insertion aperture of the lock section to secure the connecting element around the cable strand,
wherein the assembly station is configured to automatically position the retaining section around the cable strand and insert the free end of the retaining section into the lock section to mount the connecting element on the cable strand.
